(19) United States
(12) Patent Application Publication
(10) Pub. No.: US 2009/0289906 A1
(43) Pub. Date: Nov. 26, 2009

(54) METHOD AND SYSTEM FOR CONTROLLING AN ELECTRONIC DEVICE WITH AN EXTERNAL TOUCH PANEL

(75) Inventor: CHIN-YUN HUNG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/261,052

(22) Filed: Oct. 30, 2008

(30) Foreign Application Priority Data
May 21, 2008 (CN) 200810301707.0

(51) Int. Cl. G06F 3/041

(52) U.S. Cl. 345/173

(57) ABSTRACT

A method and system for controlling an electronic device with an external touch panel are provided. The method includes retrieving applications executed on the electronic device by an interface, displaying user interfaces of the retrieved applications, detecting coordinates of a contacted point on the external touch panel, generating an analog signal in accordance with detection results, converting the analog signal from the touch panel into a digital signal, and outputting the digital signal to the electronic device to synchronize operations of the electronic device with the touch panel.

### BACKGROUND

1. Field of the Invention

Embodiments of the present disclosure relate to touch panel control, and more particularly to a method and system for controlling an electronic device with an external touch panel.

2. Description of Related Art

Touch panels are utilized in many electronic devices, providing an improved input means with advantages of convenience and ease of use over typical keypad-style input. Menu selections to access data or activate functions are easily and quickly made.

A typical touch panel includes a sensing unit for detecting and locating contact made with a display panel. When a specific point is contacted, a location of the contact is transmitted to a touch panel controller. The touch panel controller analyzes the location of the contact according to a coordinate system, and transmits location coordinates of the contact and/or the associated function of the icon in the contact to a central processing unit (CPU) of an electronic product employing the touch panel.

However, typical electronic products without the touch panel are unable to provide the convenience of controlling the electronic products by simply touching a display of the electronic product.

Accordingly, a method and a system for controlling an electronic device are called for in order to overcome the limitations described.

### SUMMARY

A computer-implemented method for controlling an electronic device including a display by an external touch panel. The method includes retrieving applications executed on the electronic device by an interface, displaying user interfaces of the retrieved applications, detecting coordinates of a contacted point on the external touch panel, generating an analog signal in accordance with detection results, converting the analog signal from the touch panel into a digital signal, and outputting the digital signal to the electronic device to synchronize operations of the electronic device with the touch panel.

Other advantages and novel features of the present method and system for controlling an electronic device with an external touch panel will become more apparent from the following detailed description of certain inventive embodiments when taken in conjunction with the accompanying drawings.

### BRIEF DESCRIPTION OF THE DRAWINGS

FIG. 1 is a block diagram of an embodiment of a system for controlling an electronic device with an external touch panel;

FIG. 2 shows one illustrated example of the system of FIG. 1 connected to an electronic device by an interface; and

FIG. 3 is a flowchart of an embodiment of a method for controlling an electronic device with an external touch panel.

### DETAILED DESCRIPTION OF CERTAIN INVENTIVE EMBODIMENTS

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

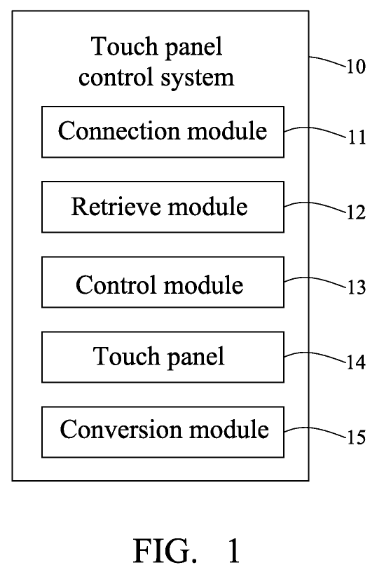

FIG. 1 is a block diagram of an embodiment of a system 10 for synchronizing a second electronic device 2 with a touch panel 14 (hereinafter “the system 10”). In one embodiment, a first electronic device 1, such as a mobile phone, connects to the second electronic device 2 and includes the system 10 having the touch panel 14 for controlling the second electronic device 2 with the touch panel 14. Portable and non-portable electronic devices other than the mobile phone shown here, such as notebook computers and personal digital assistants (PDAs), for example, may equally utilize the system 10, without departing from the spirit of the disclosure.

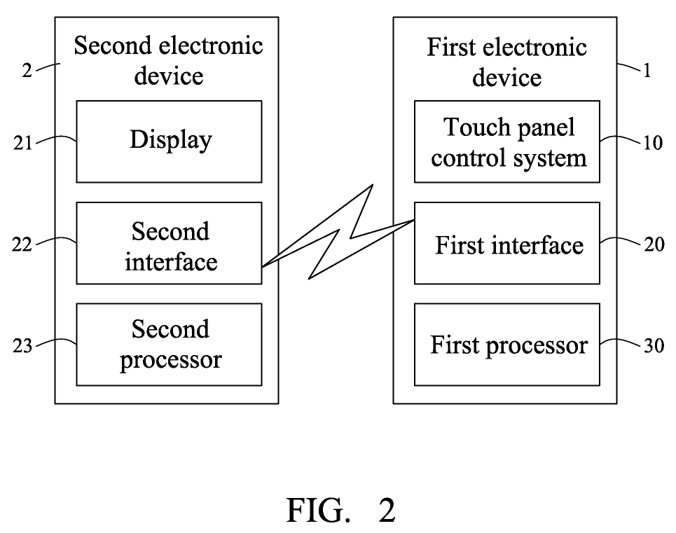

FIG. 2 shows one illustrated example of the first electronic device 1 connected to the electronic device by a first interface 30. The first electronic device 1 includes the system 10, a first interface 20, and a first processor 30, in addition to other hardware and software components of the second electronic device 2. The first processor 30 is configured for coordinating the system 10 and the first interface 20. The first interface 20 may be a standard Universal Serial Bus (USB) interface or a BLUETOOTH interface, but the disclosure is not limited thereto.

In one embodiment, the second electronic device 2, such as a desktop computer, includes a display 21, a second interface 22, and a processor 23, in addition to other hardware and software components of the second electronic device 2. It is to be noted that the display 21 is not a touch-controllable display device. The processor 23 is configured for coordinating the display 21 and the second interface 22. The second interface 22 is the same as the first interface 20 of the first electronic device 1, and may be a standard Universal Serial Bus (USB) interface or a BLUETOOTH interface, but the disclosure is not limited thereto. As shown in FIG. 2, the first electronic device 1 connects to the second electronic device 2 by the first interface 20 thereof. In other embodiments, the second electronic device 2 may be, a notebook computer, a server, or other device, without departing from the spirit of the disclosure.

In one embodiment, the system 10 includes, in addition to the touch panel 14, a connection module 11, a retrieve module 12, a control module 13, and a conversion module 15, in addition to other hardware and software components of the system 10.

The connection module 11 is configured for establishing a local connection between the first electronic device 1 and the second electronic device 2 by the first interface 20. The retrieve module 12 is configured for retrieving applications information executed on the second electronic device 2 and for sending the retrieved applications information to the touch panel 14.

The control module 13 is configured for receiving a sync signal sent from the second electronic device 2 and for sending a sync confirmation upon receipt of the sync signal. It is to be noted that the sync signal is indicative of a sync request from the second electronic device 2.

Upon receiving the sync confirmation sent from the first electronic device 1, the second electronic device 2 sends screen settings of the display 21 to the control module 13 of the first electronic device 1. The control module 13 is further configured for sending settings confirmation in response to receipt of the screen settings from the second electronic device 2 and for sending the screen settings to the touch panel 14 so as to display user interfaces of the retrieved applications on the touch panel 14.

The touch panel 14 is configured for detecting coordinates of a contacted point dependent on the settings information and for generating an analog signal in accordance with the detection results.

The conversion module 15 is configured for converting the analog signal into digital signal and outputting the digital signal to the second electronic device 2 so as to synchronize operations of the applications executed on the second electronic device 2 with the touch panel 14.

For example, the second electronic device 2 may be executing a word processing application. After the connection between the first electronic device 1 and the second electronic device 2 is established, the retrieve module 12 retrieves information regarding the word processing application. The touch panel 14 displays user interfaces of the word processing application and detects coordinates of contacted points made by user input, such as activation a function or input of characters. The digital signals generated by the users input are then outputted to the second electronic device 2. In this way, the operations of the applications executed on the second electronic device 2 may be controlled by the system 10 of the first electronic device 1.

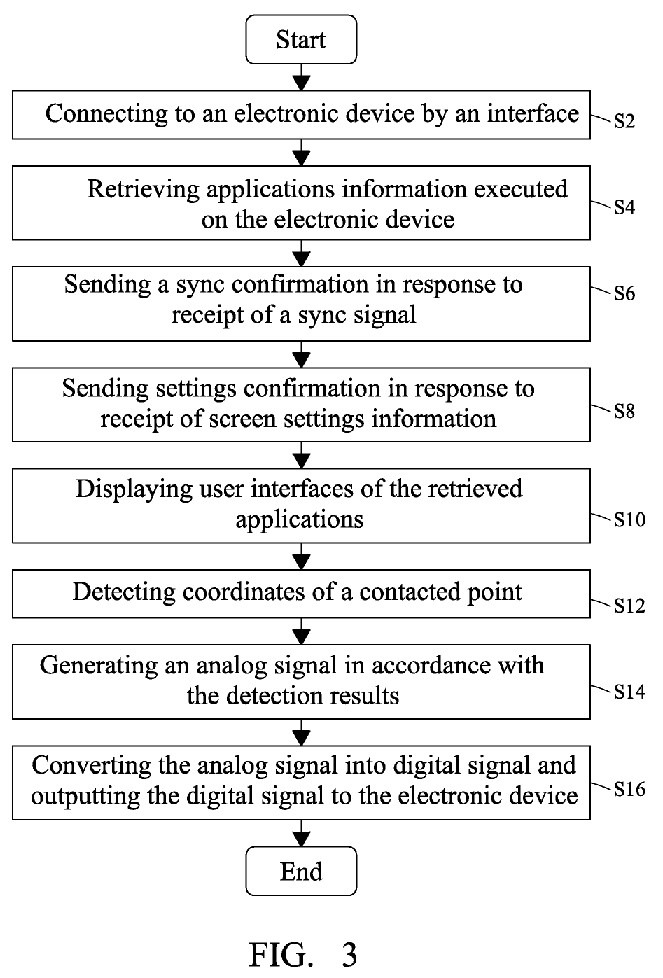

FIG. 3 is a flowchart of an embodiment of a method for controlling a second electronic device 2 with the touch panel 14. The method of FIG. 3 may used for synchronizing the operations of the applications executed on the second electronic device 2 by the touch panel 14 of the first electronic device 1. Depending on the embodiment, additional blocks may be added or deleted and the blocks may be executed in order other than that described.

In block S2, the first electronic device 1 connects to the second electronic device 2 by a first interface 20. In block S4, the retrieve module 12 retrieves applications information executed on the electronic device by the first interface 20.

In block S6, the control module 13 sends a sync confirmation in response to receipt of a sync signal. In block S8, the control module 13 sends settings confirmation in response to receipt of screen settings information.

In block S10, the touch panel 14 displays user interfaces of the retrieved applications. In block S12, the touch panel 14 detects coordinates of a contacted point. In block S14, the touch panel 14 then generates an analog signal in accordance with the detection results. In block S16, the conversion module 15 converts the analog signal from the touch panel into digital signal and outputs the digital signal to the second electronic device 2.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A touch panel control system operating on a portable electronic device for controlling an electronic device comprising a display, the system comprising:
a retrieve module for retrieving applications information executed on the electronic device by an interface;
a touch panel for displaying user interfaces of the retrieved applications and for detecting coordinates of a contacted point of the touch panel, and for generating an analog signal in accordance with the detection results; and
a conversion module for converting the analog signal from the touch panel into a digital signal and outputting the digital signal to the electronic device to synchronize operations of the electronic device with the touch panel.

2. The system as claimed in claim 1, wherein the system further comprises a control module for sending a sync confirmation in response to receipt of a sync signal indicative of a sync request sent from the electronic device.

3. The system as claimed in claim 2, wherein the control module is configured for sending settings confirmation in response to receipt of screen settings information sent from the electronic device.

4. The system as claimed in claim 3, wherein the control module is further configured for sending the screen settings information to the touch panel so as to display user interfaces of the retrieved applications on the touch panel.

5. The system as claimed in claim 1, wherein the system further comprises a connection module for connecting to the electronic device by the interface.

6. The system as claimed in claim 5, wherein the interface is a BLUETOOTH interface.

7. The system as claimed in claim 5, wherein the interface is a standard Universal Serial Bus (USB) interface.

8. A computer-implemented method for controlling an electronic device comprising a display by an external touch panel, the method comprising:
retrieving applications executed on the electronic device by an interface;
displaying user interfaces of the retrieved applications;
detecting coordinates of a contacted point on the external touch panel;
generating an analog signal in accordance with detection results;
converting the analog signal from the touch panel into a digital signal; and
outputting the digital signal to the electronic device to synchronize operations of the electronic device with the touch panel.

9. The method as claimed in claim 8, wherein before retrieving the applications, the method further comprising:
connecting the electronic device to the touch panel by an interface; and
sending a sync confirmation in response to receipt of a sync signal indicative of a sync request sent from the electronic device.

10. The method as claimed in claim 8, wherein before displaying the user interfaces of the retrieved applications, the method further comprising:
sending settings confirmation in response to receipt of screen settings information sent from the electronic device.

11. The method as claimed in claim 9, wherein the interface is a BLUETOOTH interface.

12. The method as claimed in claim 9, wherein the interface is a standard Universal Serial Bus (USB) interface
